(19) United States
(12) Patent Application Publication
(10) Pub. No.: US 2023/0405965 A1
(43) Pub. Date: Dec. 21, 2023

(54) COMPOSITE STRUCTURE FOR NOISE INSULATION APPLICABLE TO BROADBAND FREQUENCIES AND MULTIPLE COMPOSITE SHEET INCLUDING THE SAME

(71) Applicants: Hyundai Motor Company, Seoul (KR); Kia Corporation, Seoul (KR); JJNS, Yuseong -gu (KR)

(72) Inventors: Jung Wook Lee, Bucheon (KR); Myoung Ok Lee, Seoul (KR); Jong Jin Park, Sejong (KR); Jun Hyuk Kwak, Sejong (KR)

(21) Appl. No.: 18/086,045

(22) Filed: Dec. 21, 2022

(30) Foreign Application Priority Data
Jun. 16, 2022 (KR) 10-2022-0073321

(51) Int. Cl. B32B 3/12; B32B 7/02; B32B 27/08; B32B 25/08; B32B 27/32; B32B 27/36; B32B 27/30; B32B 27/40; B32B 25/12

(52) U.S. Cl. CPC B32B 3/12; B32B 7/02; B32B 27/08; B32B 25/08; B32B 27/32; B32B 27/36; B32B 27/302; B32B 27/40; B32B 25/12; B32B 2307/51; B32B 2307/102; B32B 2307/732; B32B 2605/00

(57) ABSTRACT

Provided is a composite structure for noise insulation and a multiple composite sheet including the same. The composite structure may include a first sheet layer including first hexagonal cells forming a hexagonal pattern, an elastic film layer laminated on the first sheet layer and including polymers, and a second sheet layer laminated on the elastic film layer and including second hexagonal cells forming a hexagonal pattern. The first hexagonal cell has a center at which a point where vertices of a plurality of second hexagonal cells are joined is located.

### CROSS-REFERENCE TO RELATED APPLICATION

This application claims, under 35 U.S.C. § 119(a), the benefit of and priority to Korean Patent Application No. 10-2022-0073321, filed on Jun. 16, 2022, the entire contents of which are incorporated herein by reference.

### TECHNICAL FIELD

The present disclosure relates to a composite structure for noise insulation and a multiple composite sheet including the same. The composite structure for noise insulation may be applicable to broadband frequencies.

### BACKGROUND

While a vehicle is traveling, noise generated by the operation of an engine and a driving motor enters the interior of the vehicle, and noise generated by friction between a tire and the ground also enters the interior of the vehicle through a vehicle floor.

For this reason, various types of sound-absorbing and sound-insulating materials are used to prevent vehicle noise from entering the interior of the vehicle.

A urethane foam, which is a type of conventional sound-absorbing material, may improve sound absorption performance by changing the cell structure, or improve the performance by decreasing the thickness of constituent fibers so as to make nonwoven fabric into nanofibers or microfibers.

In addition, because the performance of the sound-insulating material is proportional to the weight or thickness thereof, the performance may be improved by increasing the weight or thickness.

For this reason, when the weight and thickness of the sound-absorbing material or sound-insulating material are increased in order to enhance the performance, the weight and price of components are increased.

Meanwhile, because there is a tendency to increase the interior space in electric vehicles, there is a limitation in increasing the thickness of the sound-absorbing and insulating material. Therefore, in order to overcome the shortcomings of the traditional sound-absorbing and insulating material, a soundproofing material utilizing an acoustic meta-structure is being developed.

The traditional meta-structure has a symmetrical frame, and the sound insulation properties are effective only in the form of a pure elastic film mode. However, there is a problem with the symmetrical structure in that a resonance mode in which a zero-mass mode occurs is generated in multiple forms, so that a region where sound waves are transmitted well must exist.

Accordingly, the overall sound insulation effect is decreased, thereby being vulnerable to broadband characteristics.

In addition, when using a method of limiting variables in order to improve the characteristics of a sound insulation panel, the characteristics are controlled by the height of a frame, and thus a multilayer structure is applied to increase the thickness of the product.

Moreover, because an elastic film has large exposed areas in the symmetrical structure, it is difficult to design the elastic film to have a large basic unit structure that is highly durable and easy to change, thereby creating a constraint that a main cutoff frequency region is limited to high frequencies.

For this reason, in the related art, it is necessary to develop a composite structure that is light in weight, has a reduced thickness, and has substantially improved sound insulation performance compared to existing sound-absorbing materials by improving the conventional metamaterial structure.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is a composite structure that is light in weight, has a reduced thickness, has substantially improved sound insulation performance compared to conventional sound-absorbing materials, and is applicable to broadband sound frequencies by improving the conventional metamaterial structure, and a multiple composite sheet including the same.

The object of the present disclosure is not limited to the object mentioned above. The object of the present disclosure will become more apparent from the following description, and will be realized by ways and combinations thereof described in the claims.

In an aspect, provided is a composite structure for noise insulation. The composite structure includes: a first sheet layer including first hexagonal cells forming a hexagonal pattern, an elastic film layer laminated on the first sheet layer and including polymers, and a second sheet layer laminated on the elastic film layer and including second hexagonal cells forming a hexagonal pattern. The first hexagonal cell has a center at which a point where vertices of a plurality of second hexagonal cells are joined is located.

The first hexagonal cell may have a center at which a point where vertices of three second hexagonal cells are joined is located.

The first hexagonal cell may have a shape of a hexagon having six equal sides, and the second hexagonal cell may have a shape of a hexagon having six equal sides.

The first sheet layer and the second sheet layer may have a honeycomb structure.

One side length of the first hexagonal cell may be less than one third of an incident sound wavelength λ, and one side length of the second hexagonal cell may be less than one third of the incident sound wavelength λ.

The term “incident sound wavelength” as used herein refers to a wavelength of the incidence sound wave. The incident sound wave is a wave pattern that propagates or transmits in a particularly direction, e.g., towards the surface separating two substances (e.g., media or polymer matrix).

One side length of the first hexagonal cell may be about 10 to 30 mm, and one side length of the second hexagonal cell may be about 10 to 30 mm.

The polymer may include at least one of low-density polyethylene (LDPE), polyurethane (PU), polyethylene terephthalate (PET), polypropylene (PP), latex or any combination thereof.

The first sheet layer may have a thickness of about 0.5 to 2 mm, the second sheet layer may have a thickness of about 0.5 to 2 mm, and the elastic film layer may have a thickness of about 100 to 150 μm.

The composite structure may suitably have an overall thickness of about 1.5 to 2.5 mm, and the composite structure may have an overall width of about 50 to 150 mm.

One side length of the first hexagonal cell may suitably be about 10 to 30 mm, one side length of the second hexagonal cell may be about 10 to 30 mm, and the one side length may be adjusted depending on the magnitude of sound frequency.

In another aspect, provided is a multiple composite sheet including a plurality of composite structures as described herein. The composite structures having different widths may be alternately arranged.

Alternatively, in another aspect, provided is a multiple composite sheet including a plurality of composite structures. The composite structures having different widths may be stacked.

Also provided is a vehicle part for noise insulation. The vehicle part may include the composite structure as described herein.

Further provided is a vehicle including the vehicle part as described herein.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1A shows a three-dimensional view of an exemplary composite structure according to an exemplary embodiment of the present disclosure;

FIG. 1B shows a cross-sectional view of FIG. 1A;

FIG. 1C shows a top plan view of FIG. 1A;

FIG. 2 shows a cross-sectional view of the positions where first hexagonal cells and second hexagonal cells are bonded in a composite structure according to an exemplary embodiment of the present disclosure;

FIG. 3A shows fixation positions on a composite structure and exposed areas of an elastic film layer according to an exemplary embodiment of the present disclosure;

FIG. 3B shows movement directions of an elastic film layer in a composite structure according to an exemplary embodiment of the present disclosure;

FIG. 4 shows the result of measuring transmission loss dB versus frequency of a composite structure according to an exemplary embodiment and a comparative embodiment;

FIGS. 5A and 5B show the relationship between one side length of a hexagonal cell and an incident sound wavelength λ;

FIG. 6 shows measured dimensions in a composite structure according to an exemplary embodiment;

FIGS. 7A and 7B show the size of a composite structure based on the change in one side length of a hexagonal cell;

FIG. 8A shows a top plan view of an arrangement of composite structures on a multiple composite sheet according to an exemplary embodiment of the present disclosure;

FIG. 8B shows the sound insulation frequency range of FIG. 8A;

FIG. 9A shows a top plan view of each of composite structures stacked in a multiple composite sheet according to an exemplary embodiment of the present disclosure;

FIG. 9B shows the cross-section of a multiple composite sheet according to an exemplary embodiment; and

FIG. 9C shows the sound insulation frequency range of a multiple composite sheet according to an exemplary embodiment.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

The above and other objects, features, and advantages of the present disclosure will become more readily apparent from the following description of preferred embodiments with reference to the accompanying drawings. However, the present disclosure is not limited to the embodiments described herein but may be embodied in other forms. Rather, the embodiments disclosed herein are provided so that this disclosure will be thorough and complete, and will fully convey the concept of the invention to those skilled in the art.

Terms such as “include” or “have” are used herein and it should be understood that the terms are intended to indicate the existence of several components, functions or steps, disclosed in the specification, and it is also to be understood that greater or fewer components, functions, or steps may likewise be utilized. Also, where a portion such as a layer, film, region, plate, or the like is referred to as being “on” another portion, this includes not only the case where it is “directly on” another portion, but also the case where there is another portion in between. Conversely, when a portion such as a layer, film, region, plate or the like is referred to as being “under” another portion, this includes not only the case where it is “directly underneath” another portion, but also the case where there is another portion in between.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by gasoline, electricity, or a fuel cell.

The present disclosure relates to a composite structure for noise insulation applicable to broadband frequencies and a multiple composite sheet including the same. The configuration of the composite structure will be described in more detail as follows.

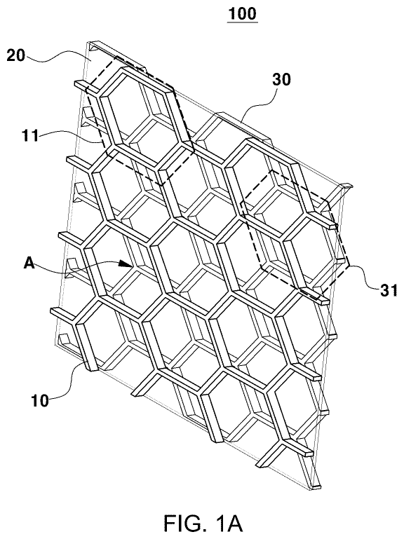

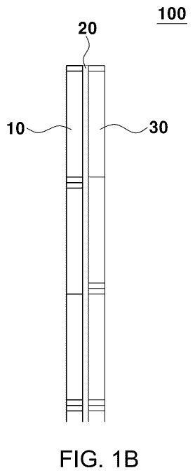

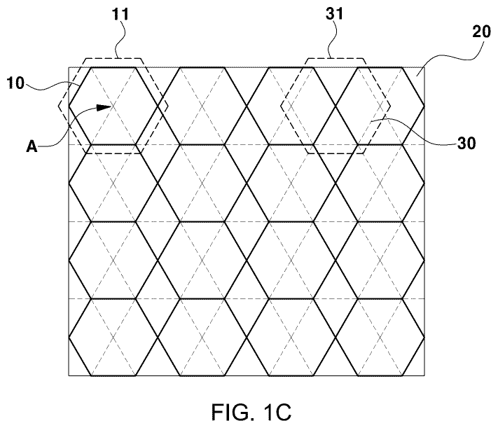

A composite structure according to the present disclosure will be described with reference to FIGS. 1A to 1C as follows. Here, FIG. 1A illustrates a three-dimensional view of an exemplary composite structure according to the present disclosure. FIG. 1B is a cross-sectional view of FIG. 1A, and FIG. 1C is a top plan view of FIG. 1A.

As shown in FIGS. 1A to 1C, a composite structure 100 according to an exemplary embodiment of the present disclosure includes a first sheet layer 10 including first hexagonal cells 11 forming a hexagonal pattern, an elastic film layer 20 laminated on the first sheet layer 10 and including polymers, and a second sheet layer 30 laminated on the elastic film layer 20 and including second hexagonal cells 31 forming a hexagonal pattern, wherein the first hexagonal cell 11 has a center at which a point A where vertices of a plurality of second hexagonal cells 31 are joined is located.

The composite structure 100 include a three-layer structure in which the first sheet layer 10, the elastic film layer 20, and the second sheet layer 30 are stacked in this order.

The first sheet layer 10 includes first hexagonal cells 11 forming a hexagonal pattern. The first hexagonal cell 11 may have a center at which a point where vertices of three second hexagonal cells 31 are joined is located. Accordingly, the first sheet layer 10 and the second sheet layer 30 may have an asymmetric bonding structure.

The second sheet layer 30 may be laminated on the elastic film layer 20, and may have second hexagonal cells 31 forming a hexagonal pattern.

The second sheet layer 30 has the same configuration as the first sheet layer 10, and is bonded to the elastic film layer 20 while being disposed asymmetrical to the first sheet layer 10.

The material of the first sheet layer 10 and the second sheet layer 30 may be any conventional injection-moldable plastic such as polypropylene (PP), polyethylene terephthalate (PET), acrylonitrile butadiene styrene (ABS), but is not limited thereto.

The first hexagonal cell 11 and the second hexagonal cell 31 may have a hexagonal shape having 6 sides that are equal in length.

Particularly, the first sheet layer 10 and the second sheet layer 30 may adopt a honeycomb structure. Here, the honeycomb structure refers to a lattice structure having an empty space in the shape of a hexagonal column.

The elastic film layer 20 converts sound waves of air into elastic waves. The elastic film layer 20 is laminated on the first sheet layer 10 and includes polymers.

The polymer may include at least one of low-density polyethylene (LDPE), polyurethane (PU), polyethylene terephthalate (PET), polypropylene (PP), latex or any combination thereof.

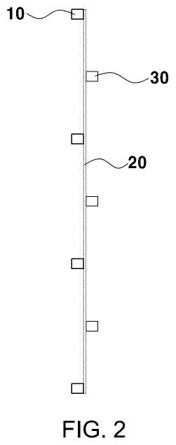

FIG. 2 shows a cross-sectional view illustrating the positions where first hexagonal cells and second hexagonal cells are bonded in a composite structure according to the present disclosure.

As shown in FIGS. 1C and 2, the first hexagonal cell 11 has a shape of a hexagon having six equal sides, and the second hexagonal cell 31 has a shape of a hexagon having six equal sides, and as such, the first hexagonal cell 11 may have a center at which a point A where vertices of the second hexagonal cells 31 are joined is located.

Particularly, the first hexagonal cell may have a center at which a point where vertices of three second hexagonal cells are joined is located.

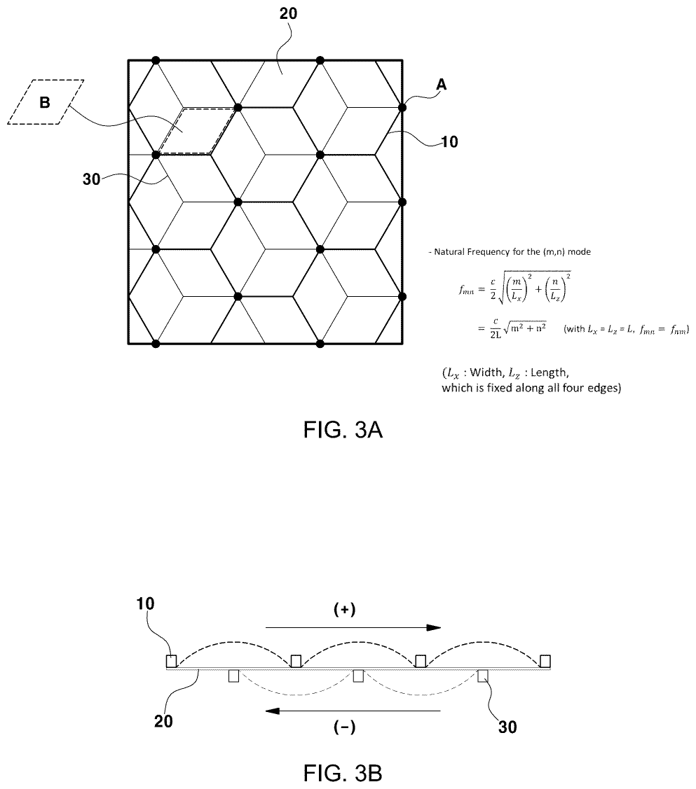

FIG. 3A illustrates fixation positions on the composite structure and exposed areas of the elastic film layer according to an exemplary embodiment of the present disclosure.

As shown in FIG. 3A, a point of the first sheet layer 10, a point of the elastic film layer and a point of the second sheet layer 30 are fixed at a position A. In addition, the elastic film layer 20 has an exposed area B due to the fixation.

Therefore, the composite structure for noise insulation according to an exemplary embodiment of the present disclosure has an asymmetric structure so as to reduce the exposure of the elastic film layer 20.

FIG. 3B illustrates movement directions of the elastic film layer in the composite structure according to an exemplary embodiment of the present disclosure.

As shown in FIG. 3B, in the movement of the elastic film layer 20, the first sheet layer moves upwards (+) in a fundamental mode, and when moving downwards (−), is shifted to have a diamond shape and moves back in the fundamental mode when viewed from the second sheet layer 30.

In other words, because the first sheet layer 10 and second sheet layer 30 move asymmetrically on the elastic film layer 20, a zero-mass mode does not occur, and thus a region to which sound wave energy is transmitted is not generated.

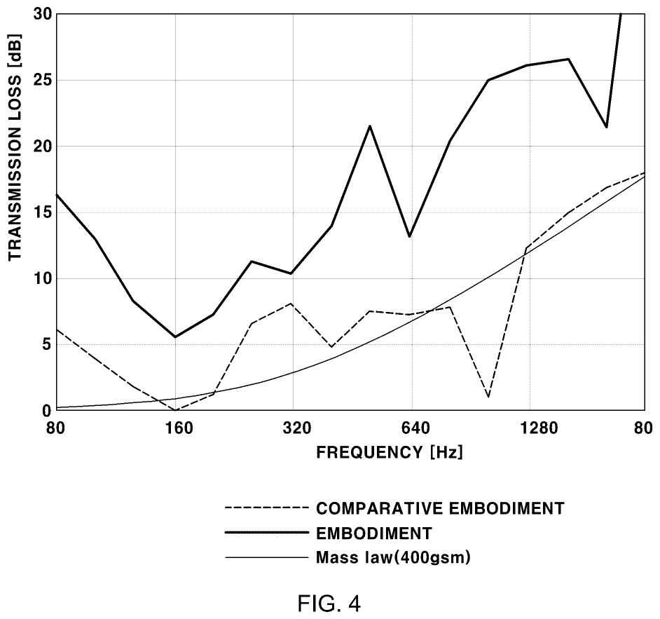

FIG. 4 illustrates the result of measuring transmission loss dB versus frequency of a composite structure according to an exemplary embodiment and to a comparative embodiment.

As shown in FIG. 4, the composite structure 100 according to an exemplary embodiment of the present disclosure does not have a zero mass effect due to the symmetrical structure thereof. In addition, the composite structure 100 according to an embodiment of the present disclosure is predicted to have higher sound insulation properties than a mass law diagram.

On the other hand, the composite structure according to an embodiment shows a tendency in which the transmission loss abruptly decreases below the mass law diagram.

Meanwhile, the conventional elastic film-structured acoustic metamaterial has a narrow frequency band in which an anti-resonance mode is generated, and thus has a disadvantage in that the transmission loss is suddenly reduced in some frequency regions. However, in the composite structure for noise insulation according to the present disclosure, a multi-anti-resonance mode-based sound insulating structure may block sound waves by dividing an area that is to be sound insulated and artificially making the motion of sound waves to be infinite.

Accordingly, in the composite structure for noise insulation according to an exemplary embodiment of the present disclosure, when one side of a similar area has a positive value and another side has a negative value, the average value becomes zero. Here, the energy of sound waves must be transmitted through the elastic film, and the net displacement of the entire elastic film becomes zero due to the anti-resonant motion of the elastic film. Accordingly, in the composite structure for noise insulation according to an exemplary embodiment of the present disclosure, the net displacement may become zero and the effective density of air may be maximized.

In addition, the composite structure for noise insulation shows broadband acoustic characteristics in which the zero-mass effect is eliminated by using a structure in which the asymmetric frame increases the area in which an anti-resonance mode is generated and cancels the resonance mode.

In the composite structure 100 according to an exemplary embodiment of the present disclosure, one side length La of first hexagonal cell 11 and the second hexagonal cell 31 may be designed in consideration of the wavelength of a frequency band to be blocked.

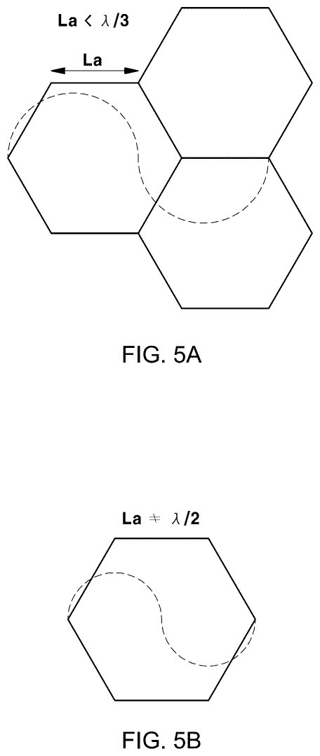

FIGS. 5A and 5B illustrate the relationship between one side length of a hexagonal cell and an incident sound wavelength λ.

As illustrated in FIG. 5A, one side length La of the first hexagonal cell may be less than one third of an incident sound wavelength λ, and one side length La of the second hexagonal cell may be less than one third of an incident sound wavelength λ.

As illustrated in FIG. 5B, because each of one side length La of the first hexagonal cell and one side length La of the second hexagonal cell is one second of the incident sound wavelength λ, the blocking effect of the incident sound may disappear.

For example, when the highest frequency fmax is specified as 10 kHz based on the broadband characteristics, the wavelength λfmax becomes 3.4 cm calculated at a speed of sound 340 m/s.

Therefore, in the composite structure 100 according to the present disclosure, the one side length La of the first hexagonal cell and the second hexagonal cell should be less than about 1.33 cm.

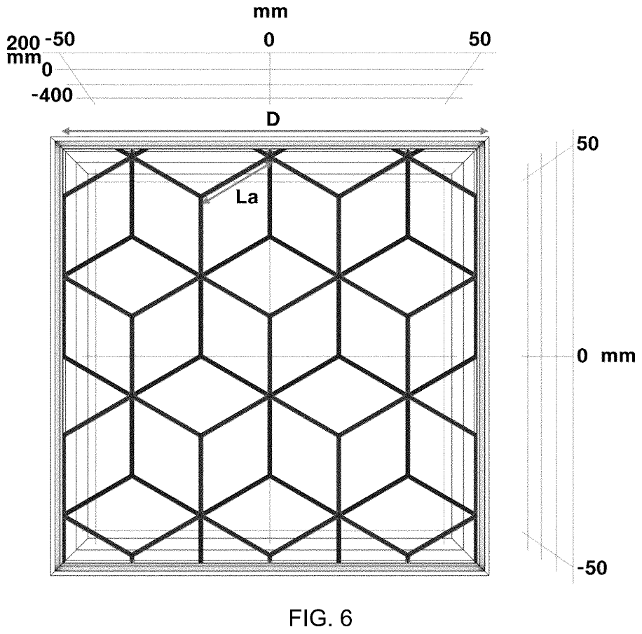

FIG. 6 shows measured dimensions in a composite structure according to an exemplary embodiment of the present disclosure.

As shown in FIG. 6, in the composite structure 100 according to an exemplary embodiment of the present disclosure, one side length La of the first hexagonal cell may be 10 to mm, and one side length La of the second hexagonal cell may be about 10 to 30 mm.

In addition, the first sheet layer may have a thickness of about 0.5 to 2 mm, the second sheet layer may have a thickness of about 0.5 to 2 mm, and the elastic film layer may have a thickness of 100 to 150 μm.

Therefore, the composite structure may have an overall thickness of about 1.5 to 2.5 mm, and the composite structure may have an overall width D of about 50 to 150 mm.

Meanwhile, in a composite structure according to an exemplary embodiment of the present disclosure, one side length La of a first hexagonal cell and a second hexagonal cell corresponding to the frequency band of the noise to be blocked may be designed to be controlled.

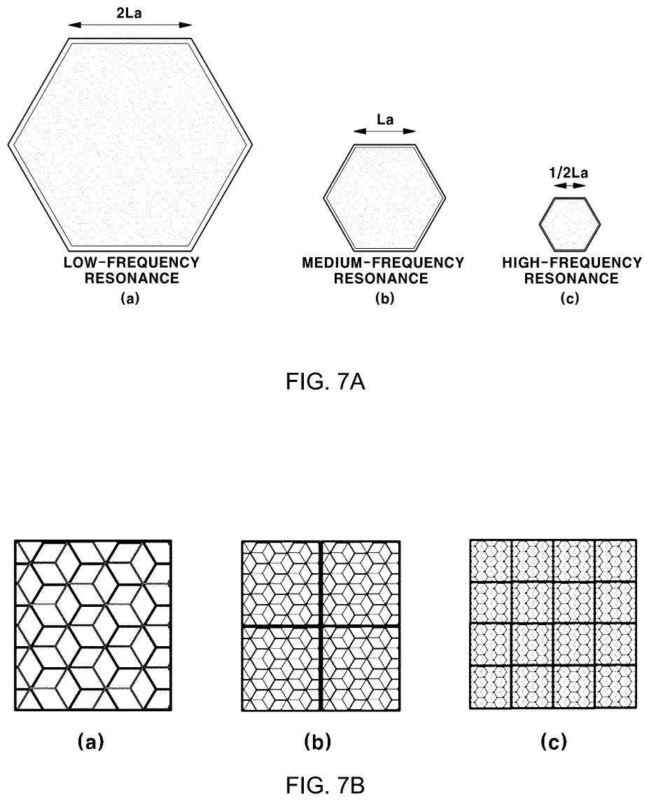

FIGS. 7A and 7B illustrate the size of a composite structure based on the change in one side length of a hexagonal cell. As shown in FIGS. 7A and 7B, as one side length La of the first hexagonal cell and the second hexagonal cell decreases, the resonant frequency increases and the area of the frame increases, thereby increasing the areal density.

For this reason, in the composite structure according to an exemplary embodiment of the present disclosure, the low frequency, the medium frequency, and the high frequency may be discriminately cut off by adjusting the one side length La of the first hexagonal cell and the second hexagonal cell.

In addition, because the composite structure for noise insulation according to an exemplary embodiment of the present disclosure may be manufactured in small size, it is possible to design a sound insulation panel capable of blocking low frequencies.

Specifically, one side length of the first hexagonal cell may be 10 to 30 mm, one side length of the second hexagonal cell may be 10 to 30 mm, and the one side length La may be adjusted depending on the magnitude of sound frequency.

In an aspect, provided is a multiple composite sheet including a composite structure for noise insulation. Hereinafter, the present disclosure will be described in more detail with reference to the accompanying drawings.

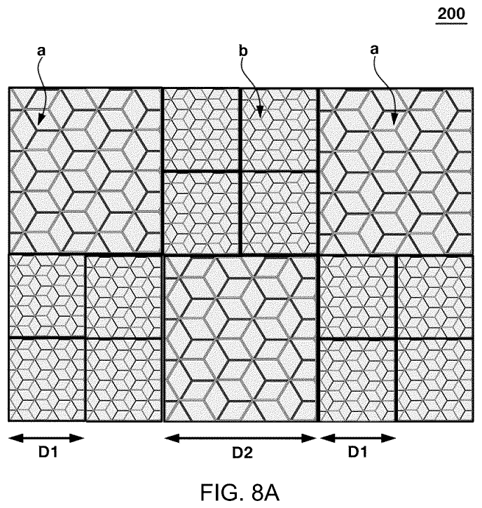

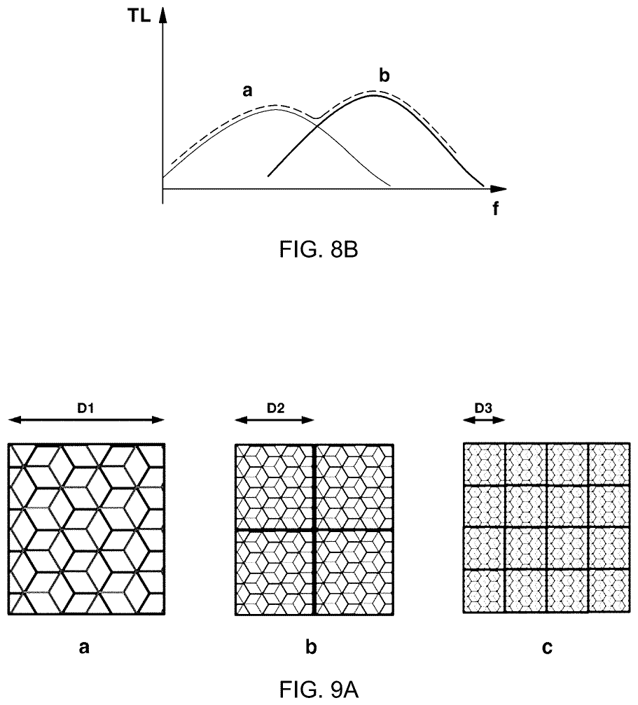

FIG. 8A shows a top plan view of an arrangement of composite structures on a multiple composite sheet according to an exemplary embodiment of the present disclosure. FIG. 8B illustrates the sound insulation frequency range of FIG. 8A.

As shown in FIG. 8A, a multiple composite sheet 200 according to an exemplary embodiment of the present disclosure may include a plurality of composite structures, that is, a composite structure a and a composite structure b, having different widths D1 and D2 that are arranged in an alternating manner. Therefore, the multiple composite sheet 200 may be a combination of a plurality of the composite structures on a plane.

As shown in FIG. 8B, as the width of the composite structure decreases, the dominant resonance frequency increases.

Therefore, in the multiple composite sheet 200 according to an exemplary embodiment of the present disclosure, various frequency regions are arranged in a plane direction to increase the bandwidth for sound insulation, thereby improving overall sound insulation performance.

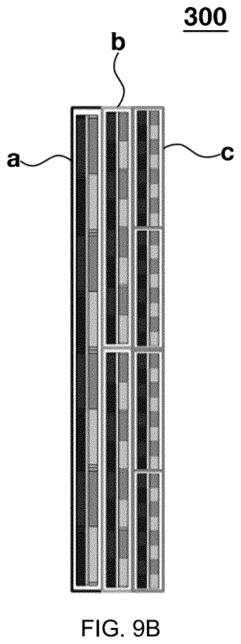

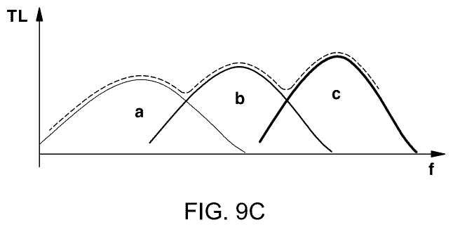

FIG. 9A shows a top plan view of each of composite structures stacked in a multiple composite sheet according to another embodiment of the present disclosure. FIG. 9B schematically illustrates the cross-section of a multiple composite sheet according to another embodiment.

As shown in FIGS. 9A and 9B, the multiple composite sheet according to an embodiment of the present disclosure may include a plurality of composite structures 300, that is, a composite structure a, a composite structure b, and a composite structure c, having different widths D1, D2, and D3 that are stacked.

Particularly, the composite structure b having a width of D2 is laminated on the composite structure a having a width of D1 to match the frequency region where the sound insulation effect is reduced. Subsequently, the composite structure c having a width of D3 may be laminated on the composite structure b to match the frequency region where the sound insulation effect is reduced.

FIG. 9C illustrates the sound insulation frequency range of a multiple composite sheet according to another embodiment.

As shown in FIG. 9C, the frequency corresponding to the characteristic of the composite structure a is reflected from the elastic film on the composite structure and the transmitted frequency corresponding to the characteristic of the composite structure b is reflected from the elastic film on the composite structure b, and accordingly, a cut-off frequency is widened.

Therefore, the multiple composite sheet 200 according to an exemplary embodiment of the present disclosure may exhibit an excellent effect in blocking a broadband frequency by using multiple stacks of the composite structure having a small thickness or applying different sizes of the plurality of the composite structures.

According to various exemplary embodiments of the present invention, the composite structure for noise insulation may improve sound insulation performance while reducing the weight and thickness thereof compared to the conventional porous sound absorbing and insulating material.

In addition, the composite structure for noise insulation may exhibit an excellent effect in blocking noise by removing the zero-mass effect using a method of increasing the area in which anti-resonance mode is generated and annihilating the resonance mode by applying an asymmetric structure.

Moreover, the multiple composite sheet may exhibit an excellent effect in blocking a broadband frequency by using multiple stacks of the composite structure having a small thickness or applying different sizes of a plurality of the composite structures.

The effects obtained by the present disclosure are not limited to the effects mentioned above.

In the above, exemplary embodiments of the present disclosure have been described. However, those skilled in the art to which the present disclosure pertains will understand that the present disclosure may be embodied in other specific forms without changing the technical idea or essential features thereof. Therefore, it should be understood that the exemplary embodiments described above are illustrative in all respects and not restrictive.

What is claimed is:

1. A composite structure for noise insulation, comprising:
a first sheet layer comprising a first hexagonal cell forming a hexagonal pattern;
an elastic film layer disposed on the first sheet layer and comprising a polymer; and
a second sheet layer disposed on the elastic film layer and comprising a second hexagonal cell forming a hexagonal pattern,
wherein the first hexagonal cell has a center at which a point where vertices of a plurality of second hexagonal cells are joined is located.

2. The composite structure according to claim 1, wherein the first hexagonal cell has a center at which a point where vertices of three second hexagonal cells are joined is located.

3. The composite structure according to claim 1, wherein:
the first hexagonal cell has a shape of a hexagon having six equal sides, and
the second hexagonal cell has a shape of a hexagon having six equal sides.

4. The composite structure according to claim 1, wherein the first sheet layer and the second sheet layer have a honeycomb structure.

5. The composite structure according to claim 1, wherein:
one side length of the first hexagonal cell is less than one third of an incident sound wavelength λ, and
one side length of the second hexagonal cell is less than one third of the incident sound wavelength λ.

6. The composite structure according to claim 1, wherein:
one side length of the first hexagonal cell is about 10 to 30 mm, and
one side length of the second hexagonal cell is about 10 to 30 mm.

7. The composite structure according to claim 1, wherein the polymer comprises at least one of low-density polyethylene (LDPE), polyurethane (PU), polyethylene terephthalate (PET), polypropylene (PP), latex or any combination thereof.

8. The composite structure according to claim 1, wherein:
the first sheet layer has a thickness of about 0.5 to 2 mm,
the second sheet layer has a thickness of about 0.5 to 2 mm, and
the elastic film layer has a thickness of about 100 to 150 μm.

9. The composite structure according to claim 1, wherein:
the composite structure has an overall thickness of about 1.5 to 2.5 mm, and
the composite structure has an overall width of about 50 to 150 mm.

10. The composite structure according to claim 1, wherein:
one side length of the first hexagonal cell is about 10 to 30 mm,
one side length of the second hexagonal cell is about 10 to 30 mm, and
the one side length is adjusted depending on a magnitude of sound frequency.

11. A multiple composite sheet, comprising:
a plurality of composite structures of claim 1,
wherein the composite structures having different widths are alternately arranged.

12. A multiple composite sheet comprising:
a plurality of composite structures of claim 1,
wherein the composite structures having different widths are stacked.

13. A vehicle part for noise insulation comprising a composite structure of claim 1.

14. A vehicle comprising a vehicle part of claim 13.
